(19) United States
(12) Patent Application Publication
(10) Pub. No.: US 2017/0318440 A1
(43) Pub. Date: Nov. 2, 2017

(54) VIRTUAL SERVING GPRS SUPPORT NODE SYSTEM AND METHOD

(71) Applicant: Tionesta, LLC, San Antonio, TX (US)

(72) Inventor: Jake Brown, Green Bay, WI (US)

(73) Assignee: Tionesta, LLC, San Antonio, TX (US)

(21) Appl. No.: 15/499,607

(22) Filed: Apr. 27, 2017

Related U.S. Application Data
(60) Provisional application No. 62/328,815, filed on Apr. 28, 2016.

(51) Int. Cl. H04W 4/16; H04W 84/12; H04L 29/08; H04W 88/06; G06F 9/455

(52) U.S. Cl. CPC H04W 4/16; H04W 84/12; H04L 67/18; G06F 2009/45595; H04W 88/06

(57) ABSTRACT

The present invention relates to a system and method for seamless interacting with the normal cellular network while providing a backend of alternative network coverage so that existing smartphone subscribers can use existing worldwide Wi-Fi networks with existing smartphones, mobile numbers and address books. Subscribers can even call and message with users who don't have the invention's services or mobile application. This is accomplished by creating a virtual Serving GPRS Support Node (vSGSN). The vSGSN is a hybrid system that facing the cellular network looks and responds as a normal SGSN, but facing the backend of the MVNO network appears as a virtual handset or in other terms is a socket through which the MVNO network interfaces with the normal cellular network.

### CLAIM OF PRIORITY TO PRIOR APPLICATION

This application claims the benefit of the filing date of U.S. Provisional Application Ser. No. 62/328,815, filed on Apr. 28, 2016, entitled “Virtual Serving GPRS Support Node System and Method”, the entire disclosure of which is hereby incorporated by reference into the present disclosure.

### STATEMENT REGARDING FEDERALLY FUNDED RESEARCH AND DEVELOPMENT

The invention described in this patent application is not the subject of federally sponsored research or development.

### FIELD

The present disclosure pertains to telecommunications networks; more particularly, the present disclosure pertains to virtualizing the functions of a Serving GPRS Support Node (SGSN).

### BACKGROUND

Wireless interconnected telecommunication services such as VoIP have long been an alternative to conventional cellular, GSM, CDMA, PBX, and other voice and messaging type communication systems and services. “VoIP” refers to “Voice over Internet Protocol,” a designation which has evolved to commonly refer to a wide array of communication protocols, technologies, methodologies, and transmission techniques involved in the delivery of voice and multimedia communication sessions over Internet Protocol (IP) networks, such as the Internet and typical Local Area hardwired and Wi-Fi networks. Within the VoIP universe, some of the more popular examples of network protocols include Session Initiation Protocol (SIP), Real-time Transport Protocol (RTP), Inter Asterisk eXchange (IAX), Session Description Protocol (SDP), H.323, and Media Gateway Control Protocol (MGCP), each of which may also include its own array of protocol permutations.

Although Wireless interconnected services and related systems are widely available as alternatives to conventional cellular-based telecommunications services in most markets, that availability has historically been dramatically diminished due to the complication and costs of setting up a conventional cellular network. In such remote, relatively non-competitive business environments, many service providers have the opportunity to lock customers onto their networks and charge exorbitant fees—for seemingly any and all device-based voice and/or data communications, whether hardwired or wireless. Moreover, end users in captive environments often receive limited voice, data, text, and Multimedia Messaging Service (MMS, a standard for picture messaging) services as compared to services available in typical metropolitan or other land-based areas. Even further challenges arise when deploying alternative telecommunication service and interfacing with the regular cellular network.

Therefore, and for many other reasons as may be known to those of ordinary skill in the art, there is a long felt unresolved need for better systems and methods for providing alternate wireless voice and data communication systems and services. Many other prior problems, limitations, obstacles and deficiencies (collectively, “challenges”) will be generally known to those of skill in the art and will otherwise be evident from the following descriptions as well as from thoughtful consideration of any claims that may be added or appended hereto or to an application claiming priority hereto.

### SUMMARY

The present invention provides carriers with Wi-Fi Calling, SMS/MMS and Rich Messaging services branded for Mobile Network Operators and Mobile Virtual Network Operator (MVNO) around the globe—all with no network changes and no capital expenditure outlay.

The present invention relates to a system and method for seamless interacting with the normal cellular network while providing a backend of alternative network coverage so that existing smartphone subscribers can use existing worldwide Wi-Fi networks with existing smartphones, mobile numbers and address books. Subscribers can even call and message with users who don't have the invention's services or mobile application.

For wireless providers, the invention offers the low-cost advantages of a standards-based, readily deployable, cloud-based platform. With no investment in new technology. It's a white label service that's ready to launch and full of opportunities for wireless subscribers and providers alike.

This is accomplished by creating a virtual Serving GPRS Support Node (vSGSN). The vSGSN is a hybrid system that facing the cellular network looks and responds as a normal SGSN, but facing the backend of the MVNO network appears as a virtual handset. In other terms, it is a socket through which the MVNO network interfaces with the normal cellular network.

### BRIEF DESCRIPTION OF THE DRAWING FIGURE

A better understanding of the disclosed system and method may be had by reference to the drawing figures wherein:

FIG. 1 is a simplified depiction of the normal dialog for cellular communication as is known in the art;

FIG. 2 is a depiction of the hybrid dialog for cellular communication as set forth in the present invention;

FIG. 3 is a more detailed depiction of the hybrid dialog for cellular communication as set forth in the present invention.

### DESCRIPTION OF THE EMBODIMENTS

As part of the description of the embodiment of the present invention it is useful to define several terms.

GPRS (General Packet Radio Service) is a telecommunications technology that enables high speed wireless internet and data communications in GSM (Global System for Mobile Communications) mobile networks.

The SGSN is a main component of a GPRS network. It serves as the access point to the network service for mobile device users. The SGSN handles all packet switched data within the network. It handles the management and authentication of the users. The SGSN is a data exchange that makes the connection between mobile users within the network, from mobile users to the public switched telephone network and from mobile users to other mobile networks.

The Visitor Location Register (VLR) is a database in a mobile communications network associated to a Mobile Switching Center (MSC).

The MSC is the primary service delivery node for GSM/CDMA, responsible for routing voice calls and SMS as well as other services (such as conference calls, FAX and circuit switched data). The VLR contains the exact location of all mobile subscribers currently present in the service area of the MSC. The primary role of the VLR is to minimize the number of queries that MSCs have to make to the home location register (HLR), which holds permanent data regarding the cellular network's subscribers. A user that is roaming is placed on the VLR which communicates this status to the HLR.

MVNOs, are wireless communications services providers who do not own the wireless network infrastructure over which the MVNO provides services to its customers.

GPRS networks create a connection between the subscriber and an external Packet Data Network (PDN) by using an Access Point Name (APN). The APN indicates which GGSN in the GPRS backbone network is to be used. At the GGSN, it may further indicate the external data network or services to which the subscriber should be connected.

A list of allowed APNs for each subscriber is stored in the HLR as a part of subscription data. The SGSN compares the APN received by a roamer in an activated context message with subscriber data in the HLR to check whether the requested service is authorized. DNS functionality is used to translate the APN to the GGSN IP address. The APN operator identifier is not stored in the HLR as part of the subscription data. It can be input by the users or inserted by an SGSN.

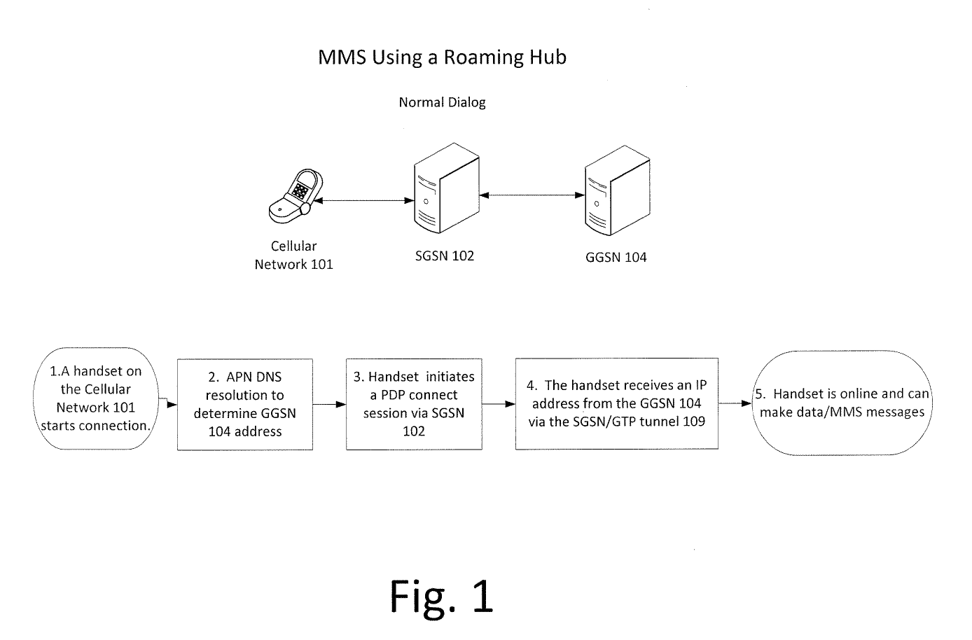

Turning to FIG. 1, the normal dialog as in known in the art can be simplified as follows: A handset on a Cellular Network 101 requests a connection and calls on the APN DNS to resolve the IP address of the GGSN 104. The handset initiates a PDP connection via the SGSN 102. The handset receives an IP address from the GGSN via the SGSN/GTP tunnel 109. The handset is now online and can send and receive data/MMS and other messages.

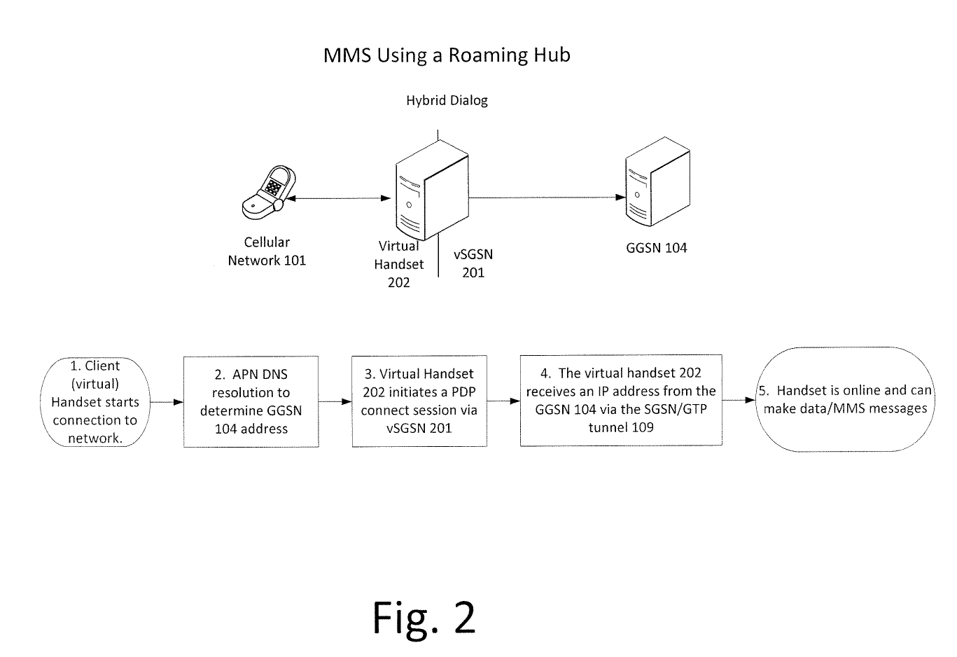

Turning to FIG. 2, the hybrid dialog of the present invention as compared to the normal dialog in the art can be simplified as follows: A client or virtual handset on a Cellular Network 101 requests a connection and calls on the APN DNS to resolve the IP address of the GGSN 104. The Virtual Handset 202 initiates a PDP connection via the vSGSN 201. The Virtual Handset 202 receives an IP address from the GGSN 104 via the SGSN/GTP tunnel 109. The handset is now online and can send and receive data/MMS and other messages.

The solution of the present can be deployed in many configurations. The most basic configuration is static in nature and allows for a carrier to extend its network using Wi-Fi. In areas that the cellular coverage is not substantial, the invention application can invoke roaming via Wi-Fi. When the application is invoked, the HLR thinks that the subscriber is housed behind the iVLR 107 (Intelligent VLR). The iVLR 107 server formats the outbound SMS and other communications and sends it to the mobile subscriber. All calls and SMS are controlled by the iVLR 107. MMSs are handled via a direct connection between the iVLR 107 and the carrier's MMSC.

To allow for a carrier to leverage their existing roaming agreements, the invention can be installed on roamed in phones. When this happens, the iVLR 107 needs to invoke unique methods to determine the IMSI of the subscriber and to find the home HLR. Once the home HLR is established the next step is to setup a unique tunnel between the carrier's vSGSN System 200 and the roamed in subscribers GGSN. This tunnel is used to access the roamed in subscriber's home MMSC via MM1.

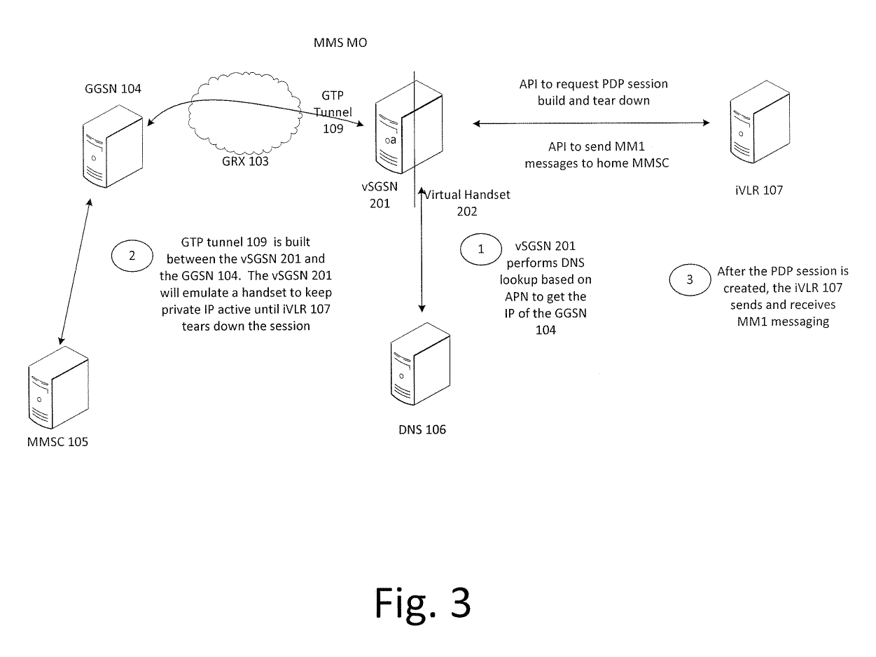

The vSGSN is more particularly described in FIG. 3. The vSGSN System 200 has SS7 connectivity as well as GRX connectivity to allow the vSGSN System 200 to receive the APN data and to perform a DNS look-up to dynamically locate the roamed in customer's GGSN. Once the GGSN is located, a GTP tunnel is established and an IP from the home network is assigned to the virtual connection that is housed in the vSGSN System 200. The Virtual Handset 202 component of the vSGSN System 200 acts as a proxy between the iVLR 107 and the home MMSC. When messages are sent to the subscriber that is roamed onto the Wi-Fi network, the message comes in via the GTP tunnel and gets sent to the iVLR 107. When the roamed in subscriber sends an MMS, the message goes out from the iVLR 107 to the virtual handset 202, to the vSGSN 201 and then to the home MMSC.

vSGSN 201 functions as SGSN when facing GGSN cell networks and looks responds like a normal SGSN. When facing the iVLR 107 and or the DNS 106 it acts as a virtual handset or conduit through which iVLR 107 can send through.

An example of how the invention works when sending or receiving a MMS is set forth below:

1. iVLR 107 gets a request to send or receive an MMS.

2. The iVLR 107 connects to a socket on the vSGSN Server 200 via the Virtual Handset 202 and signals the vSGSN Server 200 to retrieve or send the MMS. In the requests the iVLR 107 includes the IMSI of the subscriber and the APN/Operator APN.

3. The vSGSN Server 200 performs a DNS lookup via the DNS 106 to determine home GGSN 104. The query includes the APN and Operator APN. For example, internet.mnc410.mcc310.gprs. The “internet” is the phone APN and is what to query. The “mnc410.mcc310.gprs” is the operator APN and tells the network where to query.

4. Once the vSGSN Server 200 has the IP address of the GGSN 104, it launches a connection to the home GGSN via the GRX 103. The GRX 103 is the intercarrier IP network. The connection is launched using the data gathered during original registration. Once the connection is established the vSGSN Server 200 masquerades as a handset and acquires an IP address. vSGSN 201 sets up a connection or tunnel to GGSN 104 and IP addressing is assigned to the virtual subscriber.

3. The iVLR 107 uses a PDP tunnel via the vSGSN Server 200 socket to send messages to subscriber's home MMSC 105 using the acquired IP address.

This connection method is used for both sending and receiving messages.

While the present disclosure has been explained according to its preferred any alternate embodiments, those of ordinary skill will understand that variations and improvements may be made. Such variations and improvements shall be included with the scope and meaning of the appended claims.

In some embodiments of the present invention, the method and systems described are provided via computer software, either via the internet, via a stand-alone software application operating independently or in connection with other software systems, or some combination of the two. As well, embodiments may come in any known form and may also be implemented by hardware, software, scripting languages, firmware, middleware, microcode, hardware description languages, and/or any combination thereof.

When implemented with coded programming, it should also be understood that the program code or code segments to perform the necessary steps or tasks of alternative embodiments may be coded in solid state or may be stored in a machine-readable medium such as a computer storage medium. A code segment or machine-executable step or instruction may represent a procedure, a function, a subprogram, a program, a routine, a subroutine, a module, a software package, a script, a class, or any combination of instructions, data structures, and/or program statements. Executable code segments may also be coupled to other code segments or to a hardware circuit by passing and/or receiving information, data, arguments, parameters, and/or memory contents, which may be passed, forwarded, or transmitted via any suitable means including memory sharing, message passing, token passing, network transmission, etc.

Specific details are given in the above description to provide a thorough understanding of various preferred embodiments. However, it is understood that these and other embodiments may be practiced without these specific details. For example, processes may be shown in block diagrams in order not to obscure the embodiments in unnecessary detail. In other instances, well-known processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have many additional steps not included in the figure. A process may correspond to a method, a function, a procedure, a subroutine, a subprogram, etc. When a process corresponds to a function, its termination corresponds to a return of the function to the calling function or the main function.

Embodiments of the invention may involve use middleware and/or other software implementation; the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may be downloadable through an internet connection service. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

Some embodiments of the invention may not be fully enabled to complete outbound calls or send and receive texts on licensed cellular networks. Such alternative embodiments are referred to as “License-Disabled” to differentiate from other embodiments, because they fulfill most if not all the other functional and other characteristics as are described above, except that they are functionally unable to consummate an outbound call or other features as desired on a licensed cellular network. Hence, by way of example, any outbound cellular call that may be initiated by an end user with such a License-Disabled embodiment would be dropped prior to (or rather than) being connected with a licensed cellular network. It is contemplated nonetheless that such a License-Disabled embodiment could be modified after being put in use in order to add the omitted functionality, either through securing and enabling rights to transmit on licensed cellular networks, or through removing or changing the state of a component that causes the embodiment not have full functionality.

While the principles of the disclosure have been described above in connection with specific apparatuses and methods, it is to be clearly understood that this description is made only by way of example and not as limitation on the scope of the disclosure. Whether now known or later discovered, there are countless other alternatives, variations and modifications of the many features of the various described and illustrated embodiments, both in the process and in the system characteristics, that will be evident to those of skill in the art after careful and discerning review of the foregoing descriptions, particularly if they are also able to review all of the various systems and methods that have been tried in the public domain or otherwise described in the prior art. All such alternatives, variations and modifications are contemplated to fall within the scope of the present invention.

What is claimed is:

1. A method of for seamless interacting with the normal cellular network and alternative network comprising:
providing a virtual Serving GPRS Support Node (vSGSN) server with connectivity to a cellular network and a Mobile Virtual Network Operator (MVNO) backend network,
said vSGSN server comprising a microprocessor and a memory that stores mobile subscriber identifying information, wherein the microprocessor
intelligently responds, formats, and translates communications as a normal Serving GPRS Support Node (SGSN) when interfacing with a normal cellular network,
intelligently responds, formats, and translates communications as a virtual handset when interfacing with a Mobile Virtual Network Operator (MVNO) backend network,
automatically formats and translates communications using the appropriate protocols and methods including:
Signaling System No. 7 (SS7) signaling protocols,
GPRS roaming exchange (GRX) connectivity,
retrieves Access Point Name (APN) data, and
performs Domain Name System (DNS) lookups;
wherein a mobile user retains full normal function of mobile services while using alternative wireless networks.
